(19) United States
(12) Patent Application Publication
(10) Pub. No.: US 2016/0350806 A1
(43) Pub. Date: Dec. 1, 2016

(54) ADVERTISING MOBILE EQUIPMENT FOR READERS

(71) Applicant: Kwai Wing Egan Lau, Hong Kong (HK)

(72) Inventor: Kwai Wing Egan Lau, Hong Kong (HK)

(21) Appl. No.: 14/722,044

(22) Filed: May 26, 2015

(51) Int. Cl. G06Q 30/02; H04L 29/08

(52) U.S. Cl. CPC G06Q 30/0256; H04L 67/22; G06Q 30/0267

(57) ABSTRACT

According to embodiments of the disclosed technology, systems, apparatuses, methods and devices are provided for a collaborative online advertisement system for targeting users based on comments read by the user. The system displays targeted advertisements to users based on users' interaction with certain reviews, comments, and/or ratings regarding a particular product or service offered online. The system is directed to using data regarding online reviews and user perusal of online reviews to create targeted advertisements (hereinafter referred to as “ads” or “advertisements”). The disclosed technology involves using an online tool on a mobile device to browse online stores that sells consumer products. The tool recognizes and consolidates user reviews written by previous buyers of the product or products. The tool takes into account different features of the reviews such as article/comment title, review characteristics and any ratings given to a product.

### FIELD OF THE INVENTION

The present invention generally relates to advertising methods and systems and more particularly to displaying targeted advertisements to web users based on user-accessed content.

### BACKGROUND OF THE INVENTION

Online shopping is often carried out by people who value other users' evaluations of a particular product. As such, many internet commerce sights have implemented review and/or ratings systems for different products. In the context of online shopping, people would give priority to products which have received favorable ratings and reviews by trusted users. It is widely believed that more than 85% of people who shop online will make reference to a product review, and over 80% of those users will be influenced by a review.

User evaluation value is not only limited to the contents of a review. Potential buyers reading a review may pay attention to a few particularities with respect to the review. These include: i) the title of the comment in the article, ii) characteristics described and/or reviewed, and/or iii) the relevant rating for the seller of a product. Different users may value different features and/or comments of a review.

For example, some may value a number-based rating scale (e.g. 4 out of 5 stars), while others may pay particular attention to a reviewers age and/or expertise. The present invention contemplates these variations and provides ratings systems and/or advertisements based on user preferences and habits.

In view of the foregoing, an advertising system is disclosed for displaying targeted advertisements to users based on users' interaction with certain reviews, comments, and/or ratings regarding a particular product or service offered online.

### SUMMARY OF THE INVENTION

According to embodiments of the invention, systems, apparatuses, methods and devices are provided for a collaborative online advertisement system for targeting users based on comments read by the user. The system is directed to using data regarding online reviews and user perusal of online reviews to create targeted advertisements (hereinafter referred to as “ads” or “advertisements”). The disclosed technology involves using an online tool on a mobile device to browse online stores that sells consumer products. The tool recognizes and consolidates user reviews written by previous buyers of the product or products. The tool takes into account different features of the reviews such as article/comment title, review characteristics and any ratings given to a product.

In one embodiment of the disclosed technology, a collaborative online advertisement system is used for targeting users based on comments read by the user. The system employs one or more of the following components: a) a mobile device having a touch display screen; b) an online viewer tool stored within the mobile device showing sale items from an online store, wherein the online store provides a display area showing a list of past buyer comments of a given product, each comment being associated with at least one feature and a rating of the given product; c) an eye tracking component in the mobile device for identifying which words of text the user is reading by approximating current focus area of the user on the display screen, wherein the approximating of the current focus area of the user is carried out by prompting the user to indicate a preferred eye level position by having the user tap a portion of the screen that is indicative of a preferred eye level of the user; d) a keyword generator to collect keywords from the list of past buyer comments that are most interesting to users; and/or e) a target product generator, which produces product advertisements that are displayed to the user through the display screen in view of the interests of the user as reflected by the received keywords of multiple levels.

The keywords are collected and stored by: i) measuring a duration of time spent reading a line of text at the preferred eye level position by the user by measuring how frequently the user scrolls down; ii) if time spent by the user on the line of text exceeds an average read time of the user, the words contained in the line of text are deemed to be comments of particular interest to the user; iii) categorizing the words that are of particular interest to the user into keywords of multiple levels, which include: i) product level, ii) feature level, and iii) rating level; and/or; iv) reporting the categorized keywords of multiple levels back to the collaborative online advertisement system.

In a further embodiment of the disclosed system, the approximation of the current focus area accommodates certain users having a wide reading scope by facilitating user definition of a wider or longer preferred eye level area by leading the user to define the preferred eye level area with multiple touches.

In still further embodiments of the disclosed system, another collaborative online advertisement system is used for targeting users based on comments read by the user. Such a device may employ one or more of the following components: a) a mobile device having a touch display screen; b) an online viewer tool stored within the mobile device showing sale items from an online store, wherein the online store provides a display area showing a list of past buyer comments of a given product, each comment being associated with at least one feature and a rating of the given product; c) an eye tracking component in the mobile device for identifying which words of text the user is reading by approximating current focus area of the user on the display screen, wherein the approximating of the current focus area of the user is carried out by prompting the user to indicate a preferred eye level position by having the user tap a portion of the screen that is indicative of a preferred eye level of the user, further wherein approximation of the current focus area accommodates certain users having a wide reading scope by facilitating user definition of a wider or longer preferred eye level area by leading the user to define the preferred eye level area with multiple touches; d) a keyword generator to collect keywords from the list of past buyer comments that are most interesting to users; e) a target product generator that produces product advertisements to another affiliated networked user with similar interests based on i) the product level, ii) the feature level, and iii) the rating level; and/or f) a target product identifier, where a capturing device is configured to capture, in real-time, products that are in a vicinity of the mobile device that match identified criteria in the i) product level, ii) feature level, and ii) rating level, and notifying the user instantly.

In still another embodiment of the disclosed technology, another collaborative online advertisement system is used for targeting users based on comments read by the user. The system may employ one or more of the following components and/or actions: a) a mobile device with a touched display screen allowing a user to navigate the display screen; b) an online viewer tool stored within the mobile device showing sales items from an online store, wherein the online store provides a display area showing a list of past buyer comments of a given product, each comment is associated with at least one feature and a rating of the given product; c) an eye tracking component in the mobile device without using cameras, wherein the eye tracking component can identify which words of text the user is reading by approximating current focus area of a user on the display screen; d) wherein the approximating of the current focus area of the user is achieved by: i) prompting the user to indicate a preferred eye level area by having the user to touch a surface area of the mobile phone where the user feels that the height of the touched area is comfortable for viewing or browsing text so that words included on the preferred eye level area would be deemed as the line of text currently read by the user; and ii) accommodating certain users having wide reading scope with an ability to read multiple lines of text by allowing the user to define a wider or longer preferred eye level area by leading the user to define the preferred eye level area with multiple touches; e) a keyword generator to collect keywords from the list of past buyer comments that are most interesting to users by: i) measuring time of reading the multiple lines of text on the preferred eye level area by the user, as indicated by how frequent the user scroll downs the screen and the time stayed on the line of text before scrolling down to the next line; ii) if time spent by the user on the multiple lines of text exceeds an average read time by the user, the words contained in the multiple lines of text contains past buyer's comments are of particular interests to the user; iii) categorizing the words that cause various levels of slow down of the reading of the user into keywords of multiple levels, which include: 1) product level, 2) feature level, and 3) rating level; and iii) reporting the categorized keywords of multiple levels back to the collaborative online advertisement system; and f) a target product generator, which produces product advertisements to the user through the display screen in view of the interests of the user as reflected by the preferences through the received keywords of multiple levels.

A better understanding of the disclosed technology will be obtained from the following brief description of drawings illustrating exemplary embodiments of the disclosed technology.

### BRIEF DESCRIPTION OF THE DRAWINGS

FIG. 1 shows a diagram generally overviewing a mobile device display with pinpointed eye level tracking according to an embodiment of the disclosed technology.

FIG. 2 shows the mobile device of FIG. 1 with a touch gesture being performed according to embodiments of the disclosed technology.

FIG. 3 is a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

Referring now to the figures, a collaborative online advertisement system is provided for targeting users based on comments read by the user. The system displays targeted advertisements to users based on users' interaction with certain reviews, comments, and/or ratings regarding a particular product or service offered online. The system is directed to using data regarding online reviews and user perusal of online reviews to create targeted advertisements (hereinafter referred to as “ads” or “advertisements”). The disclosed technology involves using an online tool on a mobile device to browse online stores that sells consumer products. The tool recognizes and consolidates user reviews written by previous buyers of the product or products. The tool takes into account different features of the reviews such as article/comment title, review characteristics and any ratings given to a product.

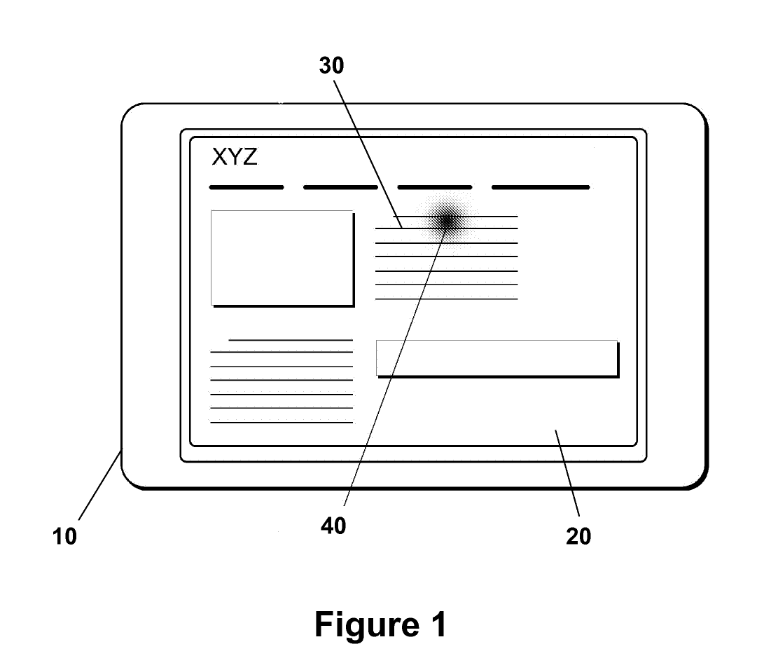

Referring now to FIG. 1, a diagram is depicted generally overviewing a mobile device display with pinpointed eye level tracking according to an embodiment of the disclosed technology. The mobile device 10 has a touch display 20 for displaying content and receiving touch gesture inputs. The display 20 may alternatively not have touch capability in which case another input/output interface would be employed by a user, such as a mouse & keyboard. The mobile device may be any computing device, including, but not limited to, a computer, a laptop, a tablet, a mobile phone, any other type of mobile device, a smart watch, any other type of wearable computer, DVD players, blu-ray players, MP3 players, cable boxes, satellite television boxes, multi-media streaming devices, satellite television receivers, digital video and/or photo cameras, and so on.

A product web page and accompanying review 30 is displayed on the display 20 of the device 10. Presumably a user (not shown) is reading the review 30 based on the duration of time during which the user is on the product review site without scrolling. The shadowed dot 40 represents the particular user's line of sight on the display 20. That is, the dot 40 is the level at which the user typically reads text displayed on the device 10. This level may be obtained through observation of the user using one or more sensors such as a camera, the touch screen and/or other input mechanisms. Alternatively, this level may be calibrated by the user by way of a simple touch gesture. Thus, the user may simply press, when prompted, the portion of the screen where the user's eyes are focused when the user is reading.

A software tool or add-on device is installed on the mobile device or accessed remotely via a data network. Based on the user's preferred eye focus area, the tool uses OCR (optical text recognition) to read, store and analyze the portions of text on which the user is most interested. This is carried out by first stipulating an average duration during which the user stays on a given page without scrolling. Different factors such as text size, amount of text, sophistication of text, addition of images, and any other variables are taken into account in quantifying this average. Once the average is determined, it is used as a benchmark by which future user actions are compared. Thus, if a user spends on average 2 minutes on a product review, but that same user spends 4 minutes on the product review for ‘Product X’, then it will be deemed that the user is more interested in Product X and/or the accompanying review.

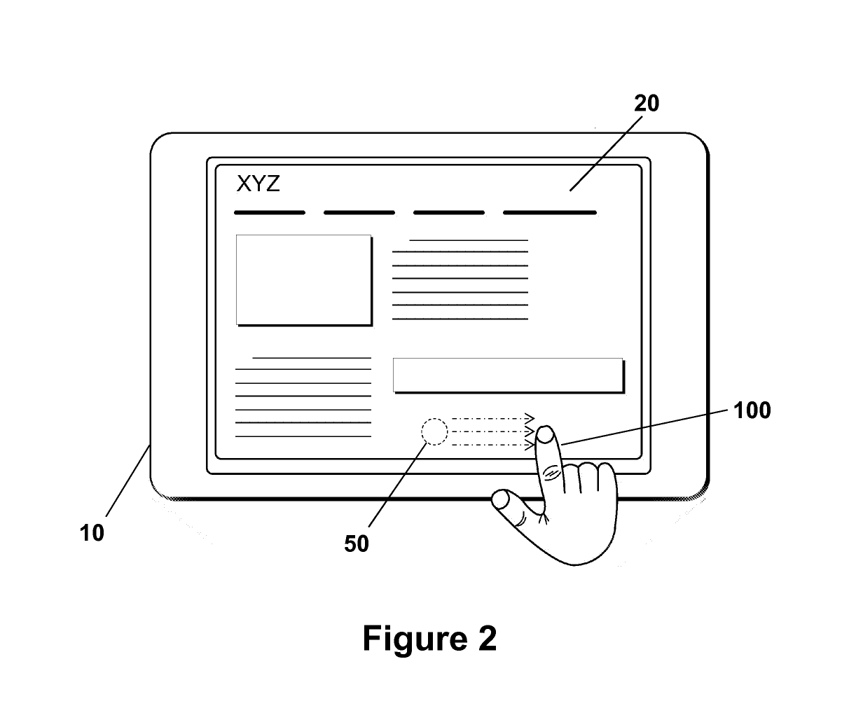

FIG. 2 shows the mobile device of FIG. 1 with a touch gesture being performed according to embodiments of the disclosed technology. The gesture 50 is being performed by a finger 100 of the user. The gesture 50 may be used as an input mechanism for defining a preferred eye focus area for a user. In this example, the user presumably is a faster reader and focuses on a large portion of a webpage or text when browsing the web. As such, the user may use multiple touches or gesture motions to define this particular preferred focus area.

The system uses this collected data regarding online reviews and user perusal of online reviews to create targeted advertisements (hereinafter referred to as “ads” or “advertisements”). Based on the keywords, the tool recognizes and consolidates user reviews written by previous buyers of the product or products. The tool takes into account different features of the reviews such as article/comment title, review characteristics and any ratings given to a product.

The tool is stored within the mobile device and may show sale items from an online store, wherein the online store provides a display area showing a list of past buyer comments of a given product, each comment being associated with at least one feature and a rating of the given product. The OCR component and a keyword generator continues to collect keywords from the list of past buyer comments that are most interesting to users. As a result, a target product generator on the device produces product advertisements that are displayed to the user through the display screen in view of the interests of the user as reflected by the received keywords of multiple levels. The advertisement may be, for example, a variation of a product for which the user is browsing reviews. This may occur if the user is spending a large duration of time reading a review which is pointing out a particular feature which may be missing in the product. As such, the advertisement may be directed to a similar product which employs the missing feature. This is merely one example of the endless possibilities for targeted ad display.

Referring specifically to the keyword aspect of the technology, the keywords are collected and stored by: i) measuring a duration of time spent reading a line of text at the preferred eye level position by the user by measuring how frequently the user scrolls down; ii) if time spent by the user on the line of text exceeds an average read time of the user, the words contained in the line of text are deemed to be comments of particular interest to the user; iii) categorizing the words that are of particular interest to the user into keywords of multiple levels, which include: a) product level, b) feature level, and c) rating level; and/or; d) reporting the categorized keywords of multiple levels back to the collaborative online advertisement system.

In further embodiments, a target product identifier may be used by the mobile device. The identifier may use a camera or other peripheral sensor of the mobile device to capture sounds, imagery and/or movement in the vicinity of the device. For example, a capturing device may be configured to capture, in real-time, products that are in a vicinity of the mobile device that match identified criteria in the i) product level, ii) feature level, and iii) rating level. The existence of such products in the vicinity of the device may be brought to the attention of the user via a pop up or other message displayed on the device.

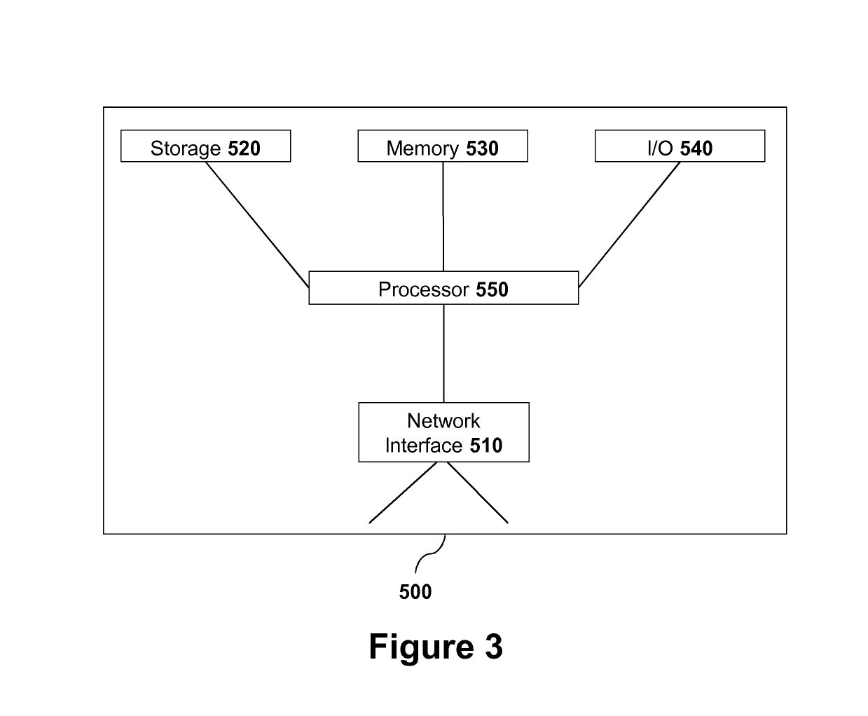

FIG. 3 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 3 is a high level representation of some of the components of such a device for illustrative purposes. It should also be understood by one skilled in the art that the method and devices depicted in FIGS. 1 and 2 may be implemented on a device such as is shown in FIG. 3.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed:

1. A collaborative online advertisement system for targeting users based on comments read by the user, comprising:
a. a mobile device having a touch display screen;
b. an online viewer tool stored within the mobile device showing sale items from an online store, wherein the online store provides a display area showing a list of past buyer comments of a given product, each comment being associated with at least one feature and a rating of the given product;
c. an eye tracking component in the mobile device for identifying which words of text the user is reading by approximating current focus area of the user on the display screen, wherein the approximating of the current focus area of the user is carried out by prompting the user to indicate a preferred eye level position by having the user tap a portion of the screen that is indicative of a preferred eye level of the user;
d. a keyword generator to collect keywords from the list of past buyer comments that are most interesting to users by:
i. measuring a duration of time spent reading a line of text at the preferred eye level position by the user by measuring how frequently the user scrolls down;
ii. if time spent by the user on the line of text exceeds an average read time of the user, the words contained in the line of text are deemed to be comments of particular interest to the user;
iii. categorizing the words that are of particular interest to the user into keywords of multiple levels, which include: i) product level, ii) feature level, and iii) rating level; and
iv. reporting the categorized keywords of multiple levels back to the collaborative online advertisement system; and
e. a target product generator, which produces product advertisements that are displayed to the user through the display screen in view of the interests of the user as reflected by the received keywords of multiple levels.

2. A system of claim 1, wherein the approximation of the current focus area accommodates certain users having a wide reading scope by facilitating user definition of a wider or longer preferred eye level area by leading the user to define the preferred eye level area with multiple touches.

3. A collaborative online advertisement system for targeting users based on comments read by the user, comprising:
a. a mobile device having a touch display screen;
b. an online viewer tool stored within the mobile device showing sale items from an online store, wherein the online store provides a display area showing a list of past buyer comments of a given product, each comment being associated with at least one feature and a rating of the given product;
c. an eye tracking component in the mobile device for identifying which words of text the user is reading by approximating current focus area of the user on the display screen, wherein the approximating of the current focus area of the user is carried out by prompting the user to indicate a preferred eye level position by having the user tap a portion of the screen that is indicative of a preferred eye level of the user further wherein approximation of the current focus area accommodates certain users having a wide reading scope by facilitating user definition of a wider or longer preferred eye level area by leading the user to define the preferred eye level area with multiple touches;
d. a keyword generator to collect keywords from the list of past buyer comments that are most interesting to users by:
i. measuring a duration of time spent reading a line of text at the preferred eye level position by the user by measuring how frequently the user scrolls down;
ii. if time spent by the user on the line of text exceeds an average read time of the user, the words contained in the line of text are deemed to be comments of particular interest to the user;
iii. categorizing the words that are of particular interest to the user into keywords of multiple levels, which include: i) product level, ii) feature level, and iii) rating level; and
iv. reporting the categorized keywords of multiple levels back to the collaborative online advertisement system; and
e. a target product generator that produces product advertisements to another affiliated networked user with similar interests based on i) the product level, ii) the feature level, and iii) the rating level.

4. The system of claim 3, further comprising:
a. a target product identifier, where a capturing device is configured to capture, in real-time, products that are in a vicinity of the mobile device that match identified criteria in the i) product level, ii) feature level, and ii) rating level, and notifying the user instantly.

5. A collaborative online advertisement system for targeting users based on comments read by the user, comprising:
a. a mobile device with a touched display screen allowing a user to navigate the display screen;
b. an online viewer tool stored within the mobile device showing sales items from an online store, wherein the online store provides a display area showing a list of past buyer comments of a given product, each comment is associated with at least one feature and a rating of the given product;
c. an eye tracking component in the mobile device without using cameras, wherein the eye tracking component can identify which words of text the user is reading by approximating current focus area of a user on the display screen;
d. wherein the approximating of the current focus area of the user is achieved by:
i. prompting the user to indicate a preferred eye level area by having the user to touch a surface area of the mobile phone where the user feels that the height of the touched area is comfortable for viewing or browsing text so that words included on the preferred eye level area would be deemed as the line of text currently read by the user; and
ii. accommodating certain users having wide reading scope with an ability to read multiple lines of text by allowing the user to define a wider or longer preferred eye level area by leading the user to define the preferred eye level area with multiple touches;
e. a keyword generator to collect keywords from the list of past buyer comments that are most interesting to users by:
i. measuring time of reading the multiple lines of text on the preferred eye level area by the user, as indicated by how frequent the user scroll downs the screen and the time stayed on the line of text before scrolling down to the next line;
ii. if time spent by the user on the multiple lines of text exceeds an average read time by the user, the words contained in the multiple lines of text contains past buyer's comments are of particular interests to the user;
iii. categorizing the words that cause various levels of slow down of the reading of the user into keywords of multiple levels, which include: i) product level, ii) feature level, and iii) rating level;
iv. reporting the categorized keywords of multiple levels back to the collaborative online advertisement system; and
f. a target product generator, which produces product advertisements to the user through the display screen in view of the interests of the user as reflected by the preferences through the received keywords of multiple levels.
